(19) United States
(12) Patent Application Publication
(10) Pub. No.: US 2019/0109463 A1
(43) Pub. Date: Apr. 11, 2019

(54) DEVICE AND METHOD FOR REGULATING A BATTERY CHARGING PROCESS

(71) Applicant: SIEMENS AKTIENGESELLSCHAFT, München (DE)

(72) Inventor: ANDRE ROMPE, BERLIN KAULSDORF (DE)

(21) Appl. No.: 16/089,669

(22) PCT Filed: Mar. 2, 2017
(86) PCT No.: PCT/EP2017/054906

§ 371 Date: Sep. 28, 2018

(30) Foreign Application Priority Data
Mar. 31, 2016 (DE) 10 2016 205 360.4

(51) Int. Cl. H02J 7/00; H01M 10/44

(52) U.S. Cl. CPC H02J 7/007; H01M 10/44; H02J 7/0004

(57) ABSTRACT

A device for regulating a battery charging process includes an input for a signal connection signaling a charging current amplitude I_{bev} preferred for charging to the device, and an output for a further signal connection allowing the device to signal a current amplitude I_{anf} for charging. The device can receive signaling of a charging current amplitude I_{emf} from the battery through the signal connection and use the received charging current amplitude I_{emf} with the preferred charging current amplitude I_{bev} for determining the required current amplitude I_{anf}. Since received charging current amplitude I_{emf} is used with preferred charging current amplitude I_{bev} to determine required current amplitude I_{anf}, the current amplitude I_{anf} can be determined for compensating current amplitude losses between charging device and battery caused, for example, by parallel connected consumers, without direct knowledge about causes of the current amplitude losses.

The present invention relates to a device and a method for regulating a battery charging process, and to a system having such a device.

Rechargeable batteries, also known as secondary batteries and referred to hereafter simply as batteries, find applications in many fields of technology. An application example is their use in drivetrains in at least partially electrically driven vehicles. One example of such vehicles are electrically operated vehicles on scheduled routes. Electric drives are therefore advantageous for vehicles on scheduled routes because the travel times along the route are usually limited and separated by periods (driving breaks), in which the battery can be charged.

When charging batteries, especially when the battery to be charged has a low charge state at the start of the charging process, a high current amplitude can occur.

The charging power is determined in this case by the current battery voltage and the amplitude of the charging current.

To prevent the charging current that is produced from damaging the battery or other components, in the so-called CCCV charging process (CCCV stands for constant current constant voltage) the charging process is regulated by the charger such that in a first phase, a charging current of constant current amplitude is provided. This is achieved by accordingly regulating the current in the first phase.

The charging device can additionally or alternatively be configured to determine the current amplitude using a battery-side preferred charging current amplitude I_{bev} and/or a battery-side preferred charging voltage U_{bev}.

The battery and/or a battery management system can be designed accordingly, to determine the preferred charging current amplitude and/or the preferred charging voltage U_{bev} and also to signal them.

According to the invention, a device according to claim 1 and a method according to claim 11 for regulating a battery charging process are provided.

The device comprises an input for a signal connection, via which input a charging current amplitude I_{bev} preferred for charging can be signaled to the device, and an output for a further signal connection, via which output the device can signal a current amplitude I_{anf} which is required for charging.

The device is additionally designed to receive signaling of a charging current amplitude I_{emf}, received from the battery via the signal connection, and to use the received charging current amplitude I_{emf} together with the preferred charging current amplitude I_{bev} for determining the required current amplitude I_{anf}.

The method according to the invention comprises appropriate steps.

Since the received charging current amplitude I_{emf} is used together with the preferred charging current amplitude I_{bev} for the determination of the required current amplitude I_{anf}, the current amplitude I_{anf} can be determined in such a way that current amplitude losses between the charging device and the battery, which can be caused, for example, by consumers connected in parallel, can be compensated without direct knowledge about causes of the current amplitude losses.

In a preferred embodiment, a charging voltage U_{bev} preferred for charging the battery can also be signaled to the device, and the device is designed to signal to the charging device a charging voltage U_{anf} required to charge the battery.

This offers advanced control options for the device, by means of which the charging process can be better regulated.

In particular, the required charging voltage U_{anf} can be equal to the preferred charging voltage U_{bev}.

This will ensure that the charging device can charge the battery with the preferred charging voltage at the battery side.

The device can be configured in such a way that via a further signal connection, at least one charging voltage U_{ber} supplied for charging the battery can be additionally signaled. The device can then be configured to determine the required current I_{anf} using the supplied charging voltage U_{ber}.

The device is thereby upgraded to take into account the supplied charging voltage U_{ber} during the charging regulation, resulting in an even more precise regulation.

The device is additionally configured such that in addition, at least one current amplitude I_{ber} supplied for charging the battery can be signaled to said device. The device is then configured to determine the required current amplitude I_{anf} using the supplied current amplitude I_{ber}.

The device is thereby upgraded to take into account the supplied charging current I_{ber} during the charging regulation, resulting in an even more accurate regulation. In particular, it is then possible to determine whether the received current amplitude I_{emf} corresponds to the supplied current amplitude I_{ber}.

The device can furthermore be designed to determine the output signal such that the required current amplitude I_{anf} compensates a difference between the preferred current amplitude I_{bev} and the received current amplitude I_{emf}.

Thus, current amplitude losses between the charging device and the battery, which can be caused, for example, by consumers connected in parallel, are compensated without direct knowledge about the causes of the current amplitude losses.

The device can be further designed to determine the output signal such that the required current amplitude I_{anf} is proportional to the difference between double the preferred charging current I_{bev} and the received current amplitude I_{emf}: I_{anf}˜2*I_{bev}−I_{emf}.

This is one form of the compensation. In particular, I_{anf}=2*I_{bev}−I_{emf} can apply.

According to the invention, a system according to claim 8 is also presented. The system comprises the device presented according to the invention and the battery. The battery comprises at least one voltage input, via which the battery can be charged by the charging device. The battery also comprises at least one output for the signal connection.

In a preferred embodiment the system further comprises the charging device, wherein the charging device comprises a voltage output connected to the voltage input of the battery for supplying a charging current for charging the battery with a current amplitude I_{ber}, and an input for the other signal connection.

The system can be designed such that a preferred charging voltage U_{bev} for charging the battery can also be signaled to the device, and the device is designed to signal to the charging device a charging voltage U_{anf} required to charge the battery, wherein the charging device can then be configured to determine the current amplitude I_{ber} using the required charging voltage U_{anf} and a supplied charging voltage U_{ber} with which the charging current is supplied.

In a preferred embodiment the method according to the invention comprises determining a voltage U_{erf} required for further charging using the preferred current amplitude I_{bev} and transmitting the determined required voltage U_{erf} to the charging device.

The above-described properties, features and advantages of the present invention and the manner in which these are achieved will become clearer and more comprehensible in conjunction with the following description of the exemplary embodiments, which are explained in more detail in connection with the drawing. Shown is:

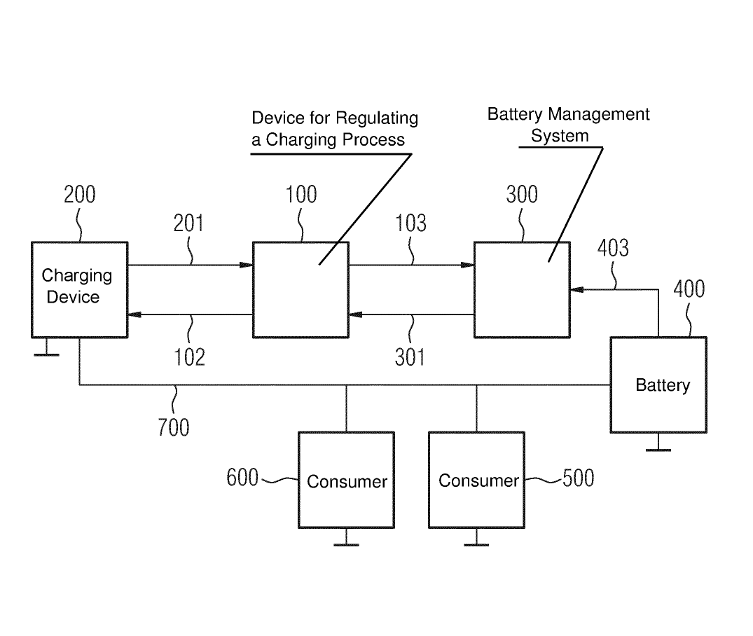

FIG. 1 a system with a device 100 for regulating a battery charging process in accordance with an exemplary embodiment of the invention.

FIG. 1 shows a system with a device 100 for regulating a charging process of a battery 400 in accordance with an exemplary embodiment of the invention. The system further comprises a charging device 200, such as a high-power charging station (HPCS). The device 100 is, for example, a microprocessor-controlled charge control device (OnBoard Charging Control, ComBox, CICU, electro vehicle charge control (EVCC)).

The charging device 200 is connected to the battery 400 via a voltage supply connection 700 for supplying a charging current. As an example, along the voltage supply connection 700 two consumers 500, 600, such as a heater and a ventilation system, are connected in parallel. The return connection is effected in the example shown via ground contacts.

In normal operation, when the battery 400 is not being charged by the charging device 200, the consumers 500, 600 are supplied with power by the battery 400 as necessary. In the charging operating mode, when the battery 400 is being charged by the charging device 200, the consumers 500, 600 are supplied with power by the charging device 200 as necessary.

The device 100 comprises a logical or physical input for a signal connection 403, 301, via which input the battery 400 signals a charging current amplitude I_{bev} preferred for charging.

The device 100 further comprises a logical or physical output for a further signal connection 102, via which the device 100 signals to the charging device 200 a current amplitude I_{anf} which is required for charging and, if appropriate, for supplying the auxiliary systems 500 and 600.

The device 100 comprises a further logical or physical input for a signal connection 201, via which the charging device 200 signals the supplied current amplitude I_{ber} to the device 100. The signal connection 201 is optional and in a further embodiment comprises signaling of the supplied voltage U_{ber}.

The device 100 additionally comprises a further logical or physical output for a further signal connection 103, via which the device 100 signals the supplied current amplitude I_{ber} of the charging current to the battery 400. The signal connection 103 is optional and in a further embodiment comprises signaling of the supplied voltage U_{ber}.

Signal connections 102, 201, 103, 301 and 403 can be implemented by a bus system. The bus system can also implement the voltage supply connection 700.

The device 100 also receives signaling of a charging current amplitude I_{emf} from the battery 400, via the signal connection 403, 301. The device 100 uses the received charging current amplitude I_{emf} together with the preferred charging current amplitude I_{bev} for the determination of the required current amplitude I_{anf}. In a further embodiment, the signal connection 403, 301 comprises signaling of a preferred charging voltage U_{bev}.

In the illustrated example, the signal connection 403, 301 comprises a battery management system 300, which receives via partial signal connection 403, from the battery 400, signaling of the received charging current amplitude I_{emf} and the preferred charging current amplitude I_{bev}, and which via partial signal connection 301 signals the received charging current amplitude I_{emf} and the preferred charging current amplitude I_{bev} to the device 100.

The device 100 is further designed to determine the output signal such that the required current amplitude I_{anf} compensates a difference between the preferred charging current amplitude I_{bev} and the received charging current amplitude I_{emf}.

In this way, current amplitude losses between the charging device 200 and the battery 400, which can be caused by consumers 500, 600 connected in parallel along the voltage supply connection 700, for example, a heater and a ventilation unit or an air-conditioning unit, are compensated without direct knowledge about the causes and the amount of the current amplitude losses.

The compensation can take place in different ways. The aim of the compensation is to minimize the difference between I_{bev}−I_{emf} for each point in time, in particular, such that I_{bev}−I_{emf} is always equal to zero.

In one exemplary embodiment the required current amplitude I_{anf} is proportional to the difference between double the preferred charging current I_{bev} and the received charging current amplitude I_{emf}:

I_{anf}˜2*I_{bev}−I_{emf}. In a specific embodiment of this example I_{anf}=2*I_{bev}−I_{emf}. If a difference exists between I_{bev} and I_{emf}, this will be immediately and fully compensated by the regulation. If, on the other hand, there is no difference, then I_{anf}=I_{bev}.

The device can also be upgraded to the effect that it also provides protection for the battery against being energized too highly during load shedding, in other words if a parallel-connected consumer is switched off during the charging process. This can be achieved if the device 100 is designed to determine, in addition to the required current amplitude I_{anf}, a voltage U_{erf} required for supplying the preferred current amplitude I_{bev} and to transfer it to the charging device. The preferred current amplitude I_{bev} is equivalent namely to a charging state of the battery and therefore to a voltage U_{erf} required for further charging, which is less than a final voltage U_{fin}, to which the charging process is fundamentally limited and with which an almost fully charged battery must be charged. If load shedding is taking place, this causes a voltage limitation on the required voltage U_{erf}, that the charging device only delivers the current amplitude to be required according to load shedding. In particular, an independent voltage limitation on the final voltage U_{fin} is unnecessary, since the required voltage U_{erf} asymptotically approaches the final voltage U_{fin} with increasing charge state of the battery.

In an exemplary embodiment of the method according to the invention, a charging process of a battery is regulated, wherein the charging process takes place by means of a charging device in accordance with a transmitted required current amplitude I_{anf}. To this end a current amplitude I_{bev} preferred for charging the battery is received, for example from the battery or from a control unit. In addition, a current amplitude I_{emf} received by the battery is received, for example from the battery or from the control unit. Then, a required current amplitude I_{anf} is determined using the received current amplitude I_{emf} and the preferred current amplitude I_{bev}. Finally, the determined required current amplitude I_{anf} is transmitted to the charging device.

The invention can be used, for example, for charging processes of at least partially electrically driven vehicles. The result achieved by the compensation is that the battery reaches a specific state of charge within a predetermined charging period, regardless of whether the additional consumers are operating or not. This is particularly advantageous for electric or hybrid powered vehicles on scheduled routes with charging periods that are limited by scheduled travel times.

Although the invention has been illustrated and described in greater detail by means of preferred exemplary embodiments, the invention is not restricted by the examples disclosed and other variations can be derived therefrom by the person skilled in the art without departing from the scope of protection of the invention.

1-12. (canceled)

13. A device for regulating a battery charging process, the device comprising:
an input for a signal connection, said input permitting a charging current amplitude I_{bev} preferred for charging to be signaled to the device;
an output for a further signal connection, said output permitting the device to signal a required current amplitude I_{anf};
the device being configured to receive signaling of a charging current amplitude I_{emf} received from the battery through said signal connection or another signal connection, and to use the received charging current amplitude I_{emf} together with the preferred charging current amplitude I_{bev} for determining the required current amplitude I_{anf}; and
the device being configured to determine the required current amplitude I_{anf} by using at least one current amplitude I_{ber} supplied for charging the battery to be additionally signaled to the device.

14. The device according to claim 13, wherein a preferred charging voltage U_{bev} for charging the battery can also be signaled to the device, and the device is configured to signal a charging voltage U_{anf} required to charge the battery to a charging device.

15. The device according to claim 14, wherein the required charging voltage U_{anf} is equal to the preferred charging voltage U_{bev}.

16. The device according to claim 13, which further comprises a further signal connection through which at least one charging voltage U_{ber} supplied for charging the battery can be additionally signaled to the device, the device being configured to determine the required current amplitude I_{anf} by using the supplied charging voltage U_{ber}.

17. The device according to claim 13, wherein the device is configured to determine the output signal such that the required current amplitude I_{anf} compensates a difference between the preferred charging current amplitude I_{bev} and the received charging current amplitude I_{emf}.

18. The device according to claim 17, wherein the device is configured to determine the output signal such that the required current amplitude I_{anf} is proportional to a difference between double the preferred charging current I_{bev} and the received charging current amplitude I_{emf}: I_{anf}˜2*I_{bev}−I_{emf}.

19. A system, comprising:
a device according to claim 13;
a battery having at least one voltage input and at least one output for the signal connection; and
a charging device for charging said battery through said at least one voltage input.

20. The system according to claim 19, wherein said charging device has an input for the further signal connection and a voltage output connected to the voltage input of said battery for supplying a charging current for charging said battery with the current amplitude I_{ber}.

21. The system according to claim 20, wherein:
a preferred charging voltage U_{bev} for charging said battery can also be signaled to said device;
said device is configured to signal a charging voltage U_{anf} required to charge said battery to said charging device; and
said charging device is configured to determine the current amplitude I_{ber} by using the required charging voltage U_{anf} and a charging voltage U_{ber} with which the charging current is supplied.

22. A method for regulating a charging process of a battery being performed by a charging device according to a required current amplitude I_{anf}, the method comprising the following steps:
receiving a current amplitude I_{bev} preferred for charging the battery,
receiving a current amplitude I_{emf} received from the battery,
receiving a current amplitude I_{ber} supplied for charging the battery,
determining the required current amplitude I_{anf} by using the received current amplitude I_{emf} and the preferred current amplitude I_{bev} and the supplied current amplitude I_{ber}, and
transmitting the determined required current amplitude I_{anf} to the charging device.

23. The method according to claim 22, which further comprises determining a voltage U_{erf} required for further charging by using the preferred current amplitude I_{bev}, and transmitting the determined required voltage U_{erf} to the charging device.
